(19) United States
(12) Patent Application Publication
(10) Pub. No.: US 2025/0377260 A1
(43) Pub. Date: Dec. 11, 2025

(54) BEAM DEFLECTION SENSING SYSTEM

(71) Applicants: Chloe Jaleh Greer, Incline Village, NV (US); Ellie Grace Lowden, Incline Village, NV (US); Alexandra Silkworth Hillman, Incline Village, NV (US); Maile Snow Giansiracusa, Carnelian Bay, CA (US); Elliot Reese Daniel, Incline Village, NV (US); Calvin River Day, Incline Village, NV (US); Lilly Jane Kurashewich, Incline Village, NV (US); Chase Marin Crutchfield, Incline Village, NV (US); Sofia Angelina Alosi, Incline Village, NV (US); Kaya Isabella Hollis, Incline Village, NV (US); Katherine McKean, Incline Village, NV (US); Noah Grace Cannon, Incline Village, NV (US); Blake Lyndon Rive, Incline Village, NV (US); Lola Marie Meinnert, Incline Village, NV (US); Riley Savanah Hunt, Incline Village, NV (US); Tate James Gitchell, Incline Village, NV (US); Neils Royal Day, Incline Village, NV (US); Halen Fett Hanson, Crystal Bay, NV (US); Alexander Starrett Briggs, Incline Village, NV (US); Jesús Alberto Aguirre, Incline Village, NV (US); Ryan Alexander Arnett, Incline Village, NV (US); Liliana Marie Morrison, Incline Village, NV (US)

(72) Inventors: Chloe Jaleh Greer, Incline Village, NV (US); Ellie Grace Lowden, Incline Village, NV (US); Alexandra Silkworth Hillman, Incline Village, NV (US); Maile Snow Giansiracusa, Carnelian Bay, CA (US); Elliot Reese Daniel, Incline Village, NV (US); Calvin River Day, Incline Village, NV (US); Lilly Jane Kurashewich, Incline Village, NV (US); Chase Marin Crutchfield, Incline Village, NV (US); Sofia Angelina Alosi, Incline Village, NV (US); Kaya Isabella Hollis, Incline Village, NV (US); Katherine McKean, Incline Village, NV (US); Noah Grace Cannon, Incline Village, NV (US); Blake Lyndon Rive, Incline Village, NV (US); Lola Marie Meinnert, Incline Village, NV (US); Riley Savanah Hunt, Incline Village, NV (US); Tate James Gitchell, Incline Village, NV (US); Neils Royal Day, Incline Village, NV (US); Halen Fett Hanson, Crystal Bay, NV (US); Alexander Starrett Briggs, Incline Village, NV (US); Jesús Alberto Aguirre, Incline Village, NV (US); Ryan Alexander Arnett, Incline Village, NV (US); Liliana Marie Morrison, Incline Village, NV (US)

(21) Appl. No.: 18/738,926

(22) Filed: Jun. 10, 2024

(51) Int. Cl. G01M 5/00

(52) U.S. Cl. CPC G01M 5/0041

(57) ABSTRACT

A roof flex monitoring system includes a flex sensor flexibly attached to a truss element of a roof truss, a microcontroller for receiving flex data from the flex sensor, a processor, a memory in communication with the processor, the memory storing executable instructions that, when executed by the processor alone or in combination with other processors, cause the roof flex monitoring system to perform functions of: obtaining flex data from the flex sensor; transmitting the flex data to a processor; storing the flex data in a memory; comparing the flex data with calibrated flex data to determine a beam deflection; and comparing the snow load with a threshold value and, if the beam deflection is greater than the threshold value, generating an alert for an excessive snow load that may be displayed to a user via a graphical user interface (GUI).

### BACKGROUND

Heavy snow loads on roof structures can lead to structure damage and potential catastrophic failure. Snow loads on roof structures including a variety of residential structures, particularly in mountain communities where snow accumulations can be significant, with dense, heavy, and long-lasting, are a continuing and potentially life-threatening problem if not addressed in a timely manner.

To address these issues, various snow load monitoring methods have been devised that measure the deflection (flex) of roof trusses responsive to the snow load. If a heavy snow load is detected relative to the load bearing capacity of the roof structure, building maintenance crews can be notified to work on snow removal to prevent structural damage and unsafe conditions inside the building. Commercial solutions for snow load monitoring in roof structures such as for businesses and warehouses are typically built around an infrared (IR) beam deflection technology that is complex and expensive to install and maintain. Such solutions are not practical for most residential applications.

Hence, there is a need for beam deflection sensing system that provides for measuring the flex of roof trusses in a roof structure using low-cost sensors in combination with software applications and web-based services that provide for improved monitoring, prediction, and warning of heavy snow loads that is more particularly suitable for residential applications.

### SUMMARY

The instant application describes a beam deflection sensing system that includes a flex sensor flexibly attached to a truss element of a roof truss, a microcontroller for receiving flex data from the flex sensor, a processor, a memory in communication with the processor, the memory storing executable instructions that, when executed by the processor alone or in combination with other processors, cause the beam deflection sensing system to perform functions of: obtaining flex data from the flex sensor; transmitting the flex data to a processor; storing the flex data in a memory; comparing the flex data with calibrated flex data to determine beam deflection; and comparing the beam deflection with a threshold value and, if the beam deflection is greater than the threshold value, generating an alert for an excessive snow load that may be displayed to a user via a graphical user interface (GUI).

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 depicts an example system that implements aspects of technology being disclosed and described for a beam deflection sensing system.

FIG. 2 depicts examples of a beam deflection sensor as applied to a truss element of various roof truss types including a scissor truss and a conventional truss.

FIG. 3 depicts a cut-away view of the beam deflection sensor with a flex resistor attached to the truss element of FIG. 2 with an acrylic bond.

FIG. 4 depicts a simplified schematic diagram of the various components of the roof flex sensor including the flex sensor, a microcontroller, a battery, a voltage sensor, and a wireless interface.

FIG. 5 is a flow diagram illustrating the logical flow of monitoring flex data implemented by the beam deflection sensing system of FIG. 1.

FIG. 6 is a flow diagram illustrating the logical flow of determining an individual threshold for a user's roof as implemented by the beam deflection sensing system of FIG. 1.

FIG. 7 is a flow diagram illustrating the logical flow of generating an alert for a predicted excessive snow load as implemented by the beam deflection sensing system of FIG. 1.

FIG. 8A-8B are examples of a graphical user interface (GUI) for a login screen and a home screen of application software that may be hosted as a web service or on a mobile device by the beam deflection sensing system of FIG. 1.

FIG. 9A-9B are examples of a graphical user interface (GUI) for a data history screen and a customization screen of the application software.

FIG. 10 is an example of a graphical user interface (GUI) for an alert screen of the application software.

### DETAILED DESCRIPTION

In the following detailed description, numerous specific details are set forth by way of examples in order to provide a thorough understanding of the relevant teachings. It will be apparent to persons of ordinary skill, upon reading this description, that various aspects can be practiced without such details. In other instances, well-known methods, procedures, components, and/or circuitry have been described at a relatively high-level, without detail, in order to avoid unnecessarily obscuring aspects of the present teachings.

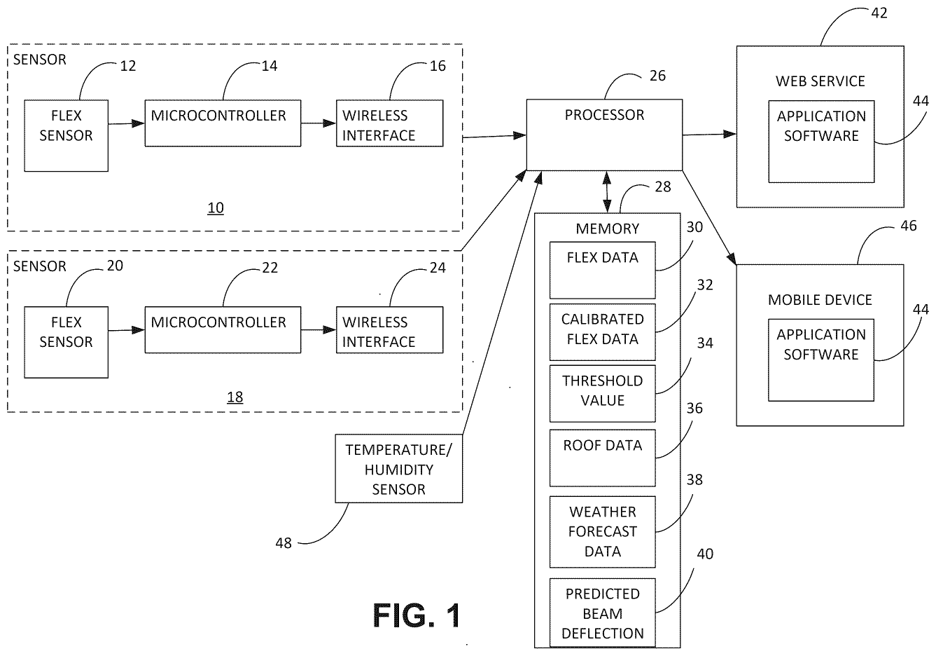

FIG. 1 depicts an example system that implements aspects of technology being disclosed and described for a beam deflection sensing system. As shown in FIG. 1, a sensor 10 may be implemented as a self-contained unit for mounting in an attic or other roof structure, the sensor 10 containing a flex sensor 12 that generates a flex signal that is received by a microcontroller 14 which may be any of a variety of microcontrollers such as an Arduino Uno that provide sufficient processing power and measurement functionality such as an on-board analog-to-digital converter (ADC) to process the flex signal to produce the flex data. A wireless interface 16 such as an Arduino Bluetooth module HC-05 or similar, is coupled to microcontroller 14 to receive the flex data and further transmit the flex data via Bluetooth or similar short-range wireless technology to a processor 26. Additional sensors 18, with flex sensor 20, microcontroller 22 and wireless interface 24, with similar implementation to the sensor 10 can be optionally added as part of the beam deflection sensing system to provide additional monitoring capabilities and redundancy as needed. A temperature/humidity sensor 48 could be further added to aid in expanding on the types of data collected by the system that may be relevant for the purpose of improved beam deflection measurement.

Processor 26 may be implemented as a Raspberry Pi in an embodiment of the invention given the desirable characteristics of the Raspberry Pi for ease of programmability, low-cost, and the dedicated use case for the beam deflection sensing system. A smartphone, personal computer, or other computing device with sufficient capabilities could be substituted. Processor 26 includes programming instructions for executing the functionality of the beam deflection sensing system as further described below.

A memory 28 coupled to the processor 26 could include on-board memory as part of a Raspberry Pi, and alternatively as a separate storage device, or part of cloud storage. Memory 28 includes sufficient capability for storing a variety of data in memory locations, the data may include flex data 30, calibrated flex data 32, threshold value 34, roof data 36, weather forecast data 38 and predicted beam deflection 40.

The processor 26 is further coupled to via an internet connection, either wired or wireless, to web service 42 running application software 44 that would provide functionality for the user via a graphical user interface (GUI) or alternatively to a mobile device 46 running a mobile version of application software 44. Many of the functions performed by the processor 26 and memory 28 could interchangeably be performed by the web service 42 or mobile device 46 as desired.

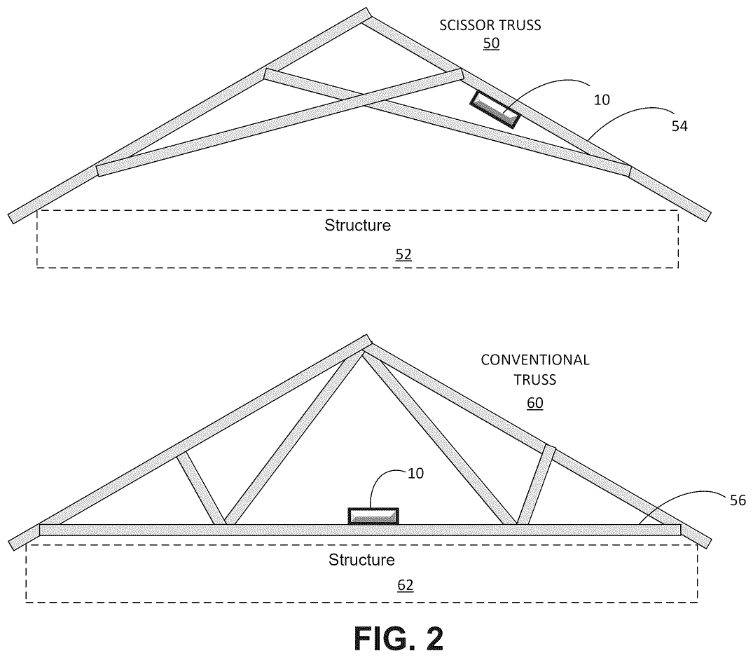

FIG. 2 depicts examples of a beam deflection sensing system as applied to a truss element of various roof truss types including a scissor truss 50 and a conventional truss 60 that are built on a structure 52 or 62 that may include a house or building. The sensor 10 may be applied to a variety of truss elements such as top chord 54 of scissor truss 50 or bottom chord 56 of conventional truss 60, with choice driven by practical considerations on what sections are accessible and whether the truss element provides a sufficient amount of flex to generate a flex signal from the flex sensor 12. The location of sensor 10 on the truss element is optimally chosen in an area of the truss element that would exhibit the most deflection of the truss element.

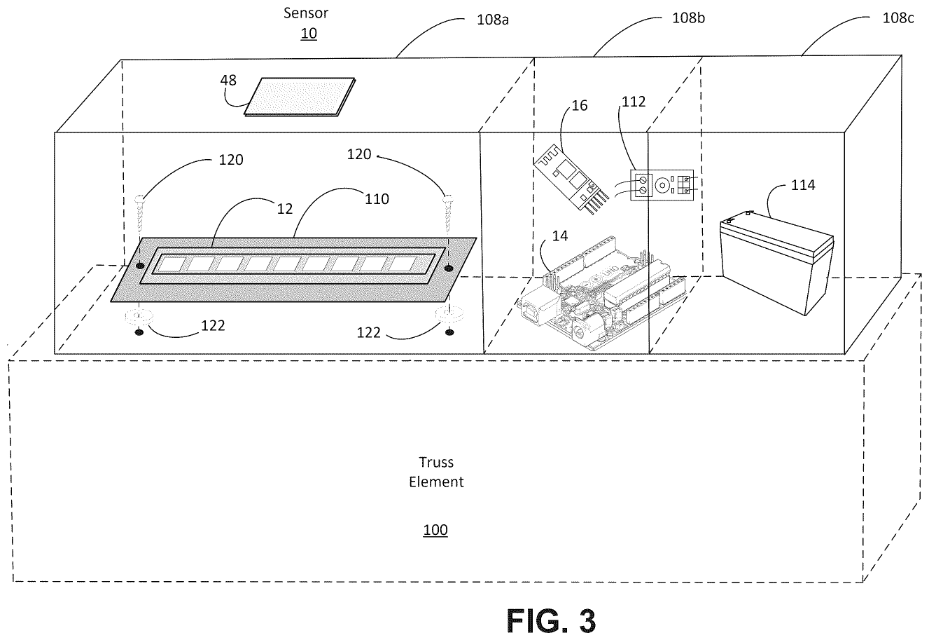

FIG. 3 depicts a cut-away view of the sensor 10 encased in a housing 108a-c, which may be implemented as a single housing collectively 108a-c, or separately as housings 108a, 108b, and 108c, that could be detached. Housing 108a containing the flex sensor 12 is attached to a truss element 100 which could be any of a variety of truss elements, including the top chord 54 or bottom chord 56 as shown in FIG. 2 that tend to exhibit beam deflection in response to a snow load on the roof structure. The flex sensor 12 is attached directly to the acrylic bond 100 such as by using an adhesive. The acrylic bond 100 in turn is mechanically attached to the truss element 100 via screws 120 or equivalent fastener, and spacers 122, the screws 120 and spacers 122 proximate to each end of the acrylic bond 100, the spacers 122 further either singular or stacked as multiple spacers 122 to provide sufficient thickness for mechanical separation between the acrylic bond 100 and the truss element 100. Other flexible structures that allow for the flexible attachment of the flex sensor 12 to the truss element 100 can also be chosen, with factors like temperature range, durability, and ease of installation considered. Mounted in the housing 108b are the microcontroller 14 and the wireless interface 16, and further including a battery 114 mounted in housing 108c to provide operating voltage for the wireless interface 16 and microcontroller 14. Battery 114 should have sufficient capacity to allow sensor 10 to operate for long periods of time without having to be replaced or recharged. Energy conservation methods such as selectively turning off the wireless interface 16 when not needed could be included. The sensor 10 may be programmed to be powered on intermittently, such as once every 3 weeks to conserve battery power. Calibrated flex data may be obtained by comparing the flex data measured during the winter to summer. Optionally, a comparison feature for the user to compare summer flex data from a previous year versus current summer flex data may be added to provide additional capability to check for any structural damage in the roof structure that may have occurred, as indicated by a significant change in summer flex data over the years. Further optionally included is a voltage sensor 112 coupled to the battery 114 that allows the microcontroller 14 to monitor battery voltage.

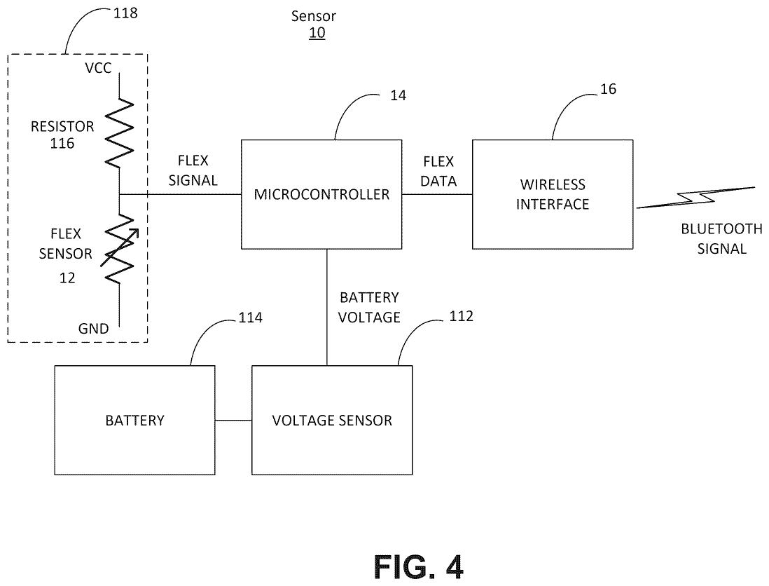

FIG. 4 depicts a simplified schematic diagram of the various components of the sensor 10 including the flex sensor 12, microcontroller 14, battery 114, voltage sensor 112, and wireless interface 16. The flex sensor 12 may be implemented using a flex sensitive resistor, with a resistance in the 25 k ohm range, in combination with a resistor 116 chosen to be 10 k ohms to form a voltage divider 118 between a regulated DC voltage Vcc and ground to provide a flex signal to microcontroller 14. The choice of DC voltage Vcc and the resistances of flex sensor 12 and resistor 116 may be chosen according to reasonable experimentation and engineering design to generate the flex signal that matches the input requirements of the microcontroller 14 and its ADC such as for desired measurement range and accuracy that best meet the needs of the beam deflection sensing system to provide the described functionality.

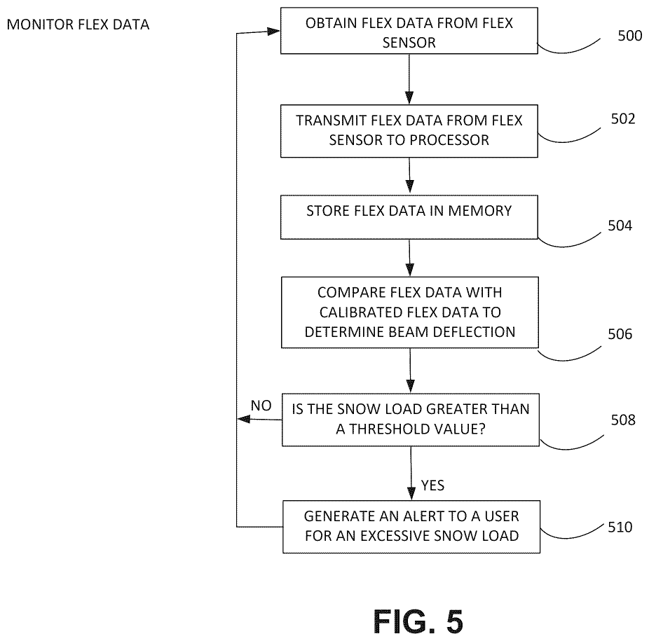

FIG. 5 is a flow diagram illustrating the logical flow of monitoring flex data implemented by the beam deflection sensing system of FIG. 1. As shown in FIG. 5, the method for monitoring flex data begins at step 500 with obtaining flex data from the flex sensor 12, which involves microcontroller 14 measuring the flex signal to produce the flex data. At step 502, the flex data is transmitted via the wireless interface 16 to the processor 26. At step 504, processor 26 stores the flex data in memory 28. At step 506, the processor compares flex data 30 with calibrated flex data 32 to determine beam deflection. Calibrated flex data 32 is flex data that was previously stored from measurements taken when the truss element 100 was not under a snow load, such as flex data measured during the summer months, which otherwise essentially had zero beam deflection in the absence of snow load. The comparison can be made mathematically as a ratio or a difference value that represents an amount of flex of the truss element 100 which in turn represents the snow load on the roof structure that may collectively include scissor truss 50 or conventional truss 60. In step 508, the beam deflection is compared to a threshold value, which represents the maximum snow load for roof structure before an alert is generated. If the beam deflection is greater than the threshold, then in step 510, an alert is generated, that may be presented audibly or shown visually via a GUI such as on the mobile device 46 or as part of the web service 42 to the user.

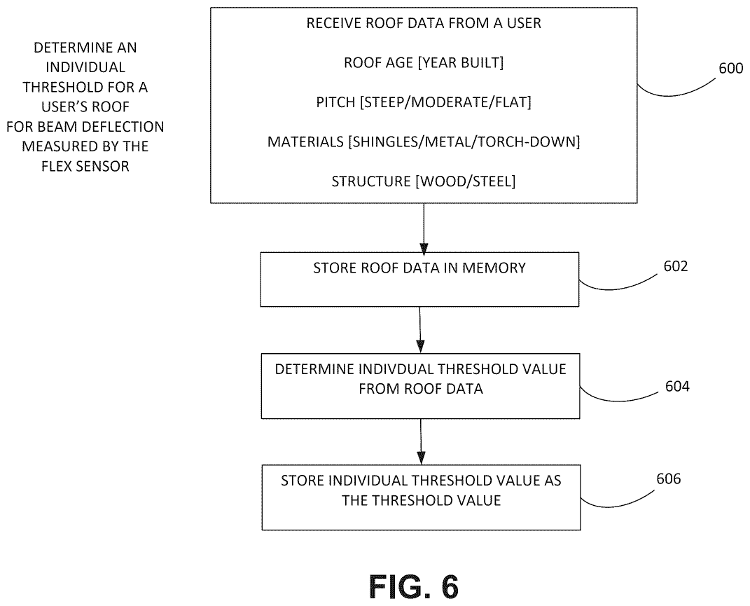

FIG. 6 is a flow diagram illustrating the logical flow of determining an individual threshold that is more precisely tailored for a user's roof as implemented by the beam deflection sensing system of FIG. 1. As shown in FIG. 6, the method for determining an individual threshold that is more precisely tailored to a particular user's roof, begins at step 600 with receiving roof data from the user, such as in response to a prompt from application software 44. The user may provide various factors that have been selected according to known engineering practices to most directly affect the maximum snow load of a particular roof design, such factors may include roof age, pitch, materials, and structure. At step 602, the roof data is stored by processor 26 in memory 28. At step 604, an individual threshold value can be determined. One method for this individual threshold determination is to adjust the threshold up or down depending on the roof data factors, as follows:

| | | Adjustment |
|---|---|---|
| Factor | Roof Data | to Threshold |
| Roof Age | New - Less than 5 years | Raise |
| | 5-20 years | 0 |
| | Old - Over 20 years | Lower |
| Pitch | Steep | Raise |
| | Moderate | 0 |
| | Flat | Lower |
| Materials | Metal | Raise |
| | Shingles | 0 |
| | Torch-Down | Lower |
| Truss Structure | Steel | Raise |
| | Laminate Wood Beam | 0 |
| | 2 × 4 Wood | Lower |

For example, a newer steep-pitch metal roof would have a higher snow load capacity than an older, flat-pitch, torch-down roof and the threshold would be adjusted to reflect that difference. In step 606, the individual threshold value that more accurately represents the snow load capacity of a user's roof is stored as the threshold value that is then part of the monitoring process shown in FIG. 5. The benefit to the user is that alerts can be more accurately generated based on the individual threshold value that is tailored to their roof structure.

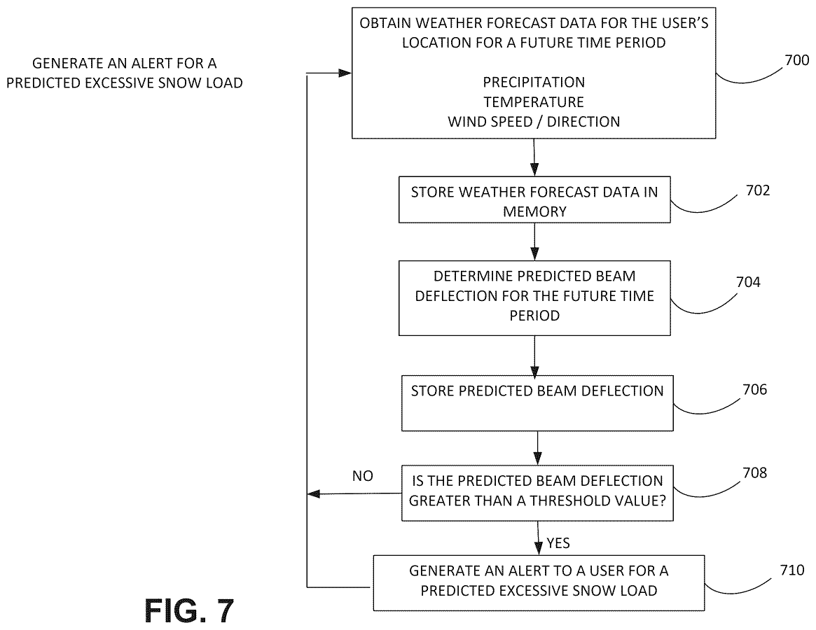

FIG. 7 is a flow diagram illustrating the logical flow of generating an alert for a predicted excessive snow load as implemented by the beam deflection sensing system of FIG. 1. As shown in FIG. 7, the method for generating an alert for a predicted excessive snow load begins at step 700 with obtaining weather forecast data for the user's location, for example a 5 day forecast from the US National Weather Service via the NOAA website www.weather.gov that provides precipitation in the form of predicted snowfall, temperatures, wind speed and direction data, among other data which can be gathered by the application program 44 running on the web service 42 or on the mobile device 46 and stored in the memory 28. In step 704, a predicted snow load can be constructed that takes into account the current snow load and additional snow load that is part of the forecast for the future time period of 5 days. Snow load calculations would typically handle not only the amount of anticipated snow accumulation, say 6″, but also the amount of moisture in the snow, light powder versus heavy wet snow, and also the amount of drifting based on wind speed and direction. Snow load calculations can be an amalgamation of known industry algorithms to produce a predicted snow load which would be stored in the memory 28 in step 706. In step 708, the predicted snow load as correlated and represented by a predicted beam deflection is compared to the threshold value as in step 508. If the predicted beam deflection is greater than the threshold, then in step 710, an alert is generated that may be presented audibly or shown visually via a GUI such as on the mobile device 46 or as part of the web service 42 to the user, with more information on the predicted excess snow load and potential for roof failure.

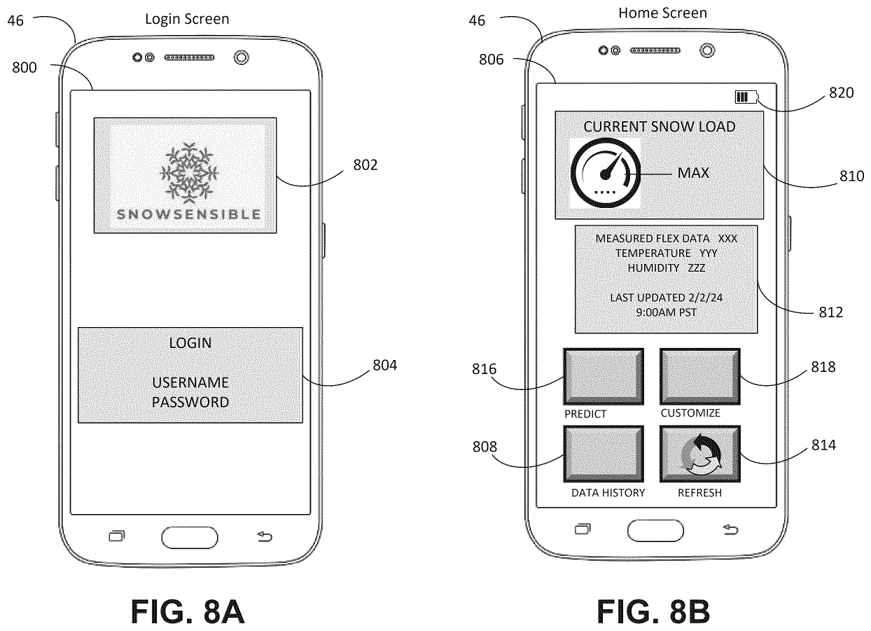

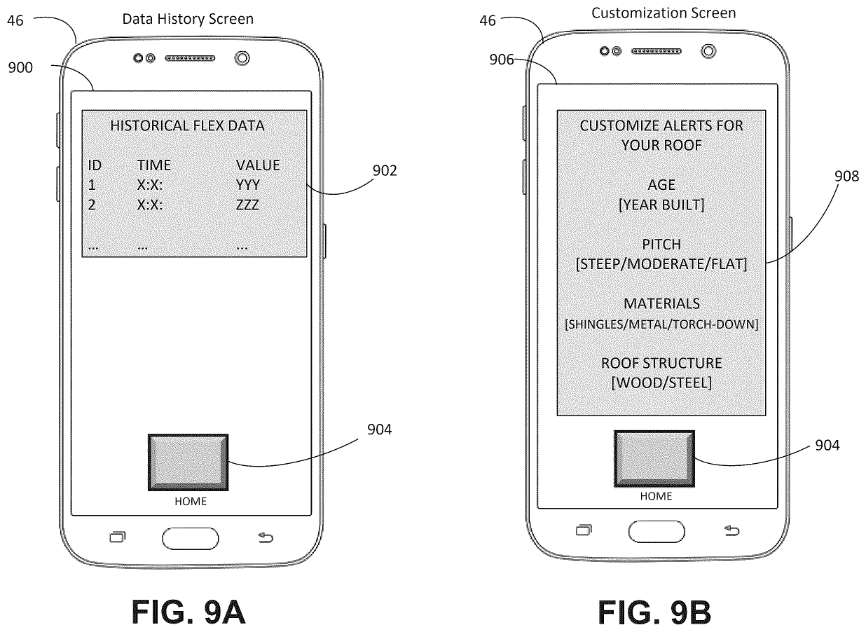

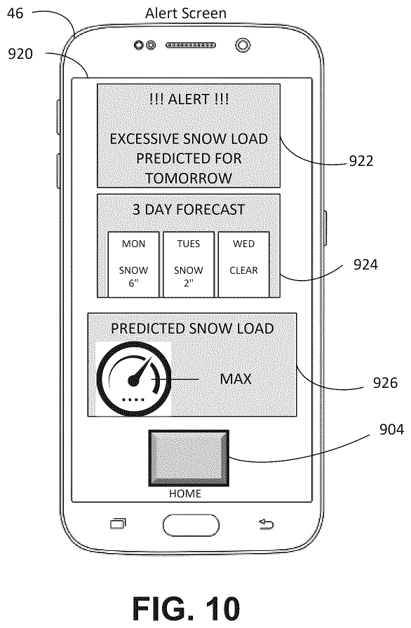

FIG. 8A-8B are examples of a graphical user interface (GUI) for a login screen 800 and a home screen 806 of application software 44 that may be hosted as a web service 42 or on a mobile device 46 by the beam deflection sensing system of FIG. 1. In FIG. 8A, on the mobile device 44, for example, the login screen 800 includes a ‘splash screen’ or logo for the application name ‘Snowsensible’ and related graphic and a login card 804 prompting for a username and password as desired, for example to control access to user data and to provide customized services and features. In FIG. 8B, the home screen 806 includes a current snow load card 810 that may be customized as a graphic element such as a gas gauge or similar in combination with numerical data on snow load. A flex data card 812 shows the most recent flex data and when it was last obtained and may also include temperature and humidity data collected by temperature/humidity sensor 48. A refresh button 814 can provide for collecting a new flex data measurement as desired. A data history button 808 can invoke a data history screen 900, shown in FIG. 9A. A predict button 816 can invoke an alert screen shown in FIG. 10. A customize button 818 can invoke a customization screen shown in FIG. 9B. A battery icon 820 can indicate the battery voltage from the voltage sensor 112 of the battery 114 or otherwise calculate a remaining battery charge.

In FIG. 9A, data history screen 900 includes a historical flex data card 92 with previously collected numerical flex data with time stamps. A home screen button 904 invokes the home screen 806 shown in FIG. 8B. In FIG. 9B, a ‘customize alerts’ card 908 is used to prompt the user to enter their roof data, implementing the method shown in FIG. 6 to obtain the individual threshold value that more accurately represents the snow load capacity of a user's roof. The home screen button 904 invokes the home screen 806 shown in FIG. 8B.

FIG. 10 is an example of a graphical user interface (GUI) for an alert screen of the application software which is invoked when an alert of any type is generated and appropriate cards are generated for displaying the alert. For example, alert card 922 displays an alert generated by the step 710 shown in FIG. 7 for predicted excessive snow load along with weather forecast card 924 that provides relevant details from the weather forecast data. Other relevant information such as a predicted snow load card 926 may also be displayed as desired to most clearly communicate the current situation to the user. The home screen button 904 invokes the home screen 806 shown in FIG. 8B.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

Generally, functions described herein (for example, the features illustrated in FIG. 1) can be implemented using software, firmware, hardware (for example, fixed logic, finite state machines, and/or other circuits), or a combination of these implementations. In the case of a software implementation, program code performs specified tasks when executed on a processor (for example, a CPU or CPUs). The program code can be stored in one or more machine-readable memory devices. The features of the techniques described herein are system-independent, meaning that the techniques may be implemented on a variety of computing systems having a variety of processors. For example, implementations may include an entity (for example, software) that causes hardware to perform operations, e.g., processors functional blocks, and so on. For example, a hardware device may include a machine-readable medium that may be configured to maintain instructions that cause the hardware device, including an operating system executed thereon and associated hardware, to perform operations. Thus, the instructions may function to configure an operating system and associated hardware to perform the operations and thereby configure or otherwise adapt a hardware device to perform functions described above. The instructions may be provided by the machine-readable medium through a variety of different configurations to hardware elements that execute the instructions.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows, and to encompass all structural and functional equivalents. Notwithstanding, none of the claims are intended to embrace subject matter that fails to satisfy the requirements of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein.

Relational terms such as first and second and the like may be used solely to distinguish one entity or action from another without necessarily requiring or implying any actual such relationship or order between such entities or actions. The terms “comprises,” “comprising,” and any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “a” or “an” does not, without further constraints, preclude the existence of additional identical elements in the process, method, article, or apparatus that comprises the element.

What is claimed is:

1. A method for monitoring roof flex in a roof truss from a flex sensor flexibly attached to a truss element of the roof truss, the method comprising:
obtaining a flex signal from the flex sensor by a microcontroller to produce flex data;
transmitting the flex data to a processor;
storing the flex data in a memory;
comparing the flex data with calibrated flex data to determine a beam deflection; and
comparing the beam deflection with a threshold value and, if the beam deflection is greater than the threshold value, generating an alert for an excessive snow load that may be displayed to a user via a graphical user interface (GUI).

2. The method of claim 1, further comprising:
obtaining the flex data from the flex sensor when the roof truss has no beam deflection;
and
storing the flex data in the memory as the calibrated flex data.

3. The method of claim 1, further comprising:
prompting the user via a customization screen of the GUI for their roof details that may include roof age, pitch, materials, and roof structure;
storing the roof data in the memory;
determining an individual threshold value from the roof data; and
storing the individual threshold value as the threshold value.

4. The method of claim 1, further comprising:
obtaining weather forecast data for the user's location for a future time period;
storing the weather forecast data in the memory;
determining a predicted beam deflection for the future time period;
storing the predicted beam deflection in the memory; and
comparing the predicted beam deflection with the threshold value, and if the predicted beam deflection is greater than the threshold value, generating an alert for predicted excessive snow load via the GUI.

5. The method of claim 1, further comprising:
receiving roof data from the user, the roof data comprising one or more of roof age, pitch, materials, and structure;
storing the roof data in the memory;
determining an individual threshold value from the roof data; and
storing the individual threshold value as the threshold value in the memory.

6. A system for monitoring roof flex in a roof truss comprising:
a processor;
a flex sensor flexibly attached to a truss element of the roof truss;
a microcontroller coupled to the flex sensor to receive a flex signal and produce flex data;
a wireless interface coupled to the microcontroller; and
a memory in communication with the processor, the memory comprising executable instructions that, when executed by the processor in combination with other processors, cause the system to perform the functions of:
measuring the flex signal by the microcontroller to produce flex data;
transmitting via the wireless interface the flex data to the processor;
storing the flex data in the memory;
comparing the flex data with calibrated flex data to determine a beam deflection; and
comparing the beam deflection with a threshold value and, if the beam deflection is greater than the threshold value, generating an alert for an excessive snow load that may be displayed to a user via a graphical user interface (GUI).

7. The system of claim 6, further comprising a web service, the web service executing application software for displaying the GUI.

8. The system of claim 6, further comprising a mobile device, the mobile device executing application software for displaying the GUI.

9. The system of claim 6, further comprising:
obtaining the flex data from the flex sensor when the roof truss has no beam deflection;
and
storing the flex data in the memory as the calibrated flex data.

10. The system of claim 6, further comprising:
prompting the user via a customization screen of the GUI for their roof details that may include roof age, pitch, materials, and roof structure;
storing the roof data in the memory;
determining an individual threshold value from the roof data; and
storing the individual threshold value as the threshold value.

11. The system of claim 6, further comprising:
obtaining weather forecast data for the user's location for a future time period;
storing the weather forecast data in the memory;
determining a predicted beam deflection for the future time period;
storing the predicted beam deflection in the memory; and
comparing the predicted beam deflection with the threshold value, and if the predicted beam deflection is greater than the threshold value, generating an alert for predicted excessive snow load via the GUI.

12. The system of claim 6, further comprising:
receiving roof data from the user, the roof data comprising one or more of roof age, pitch, materials, and structure;
storing the roof data in the memory;
determining an individual threshold value from the roof data; and
storing the individual threshold value as the threshold value in the memory.

13. A system for monitoring roof flex in a roof truss comprising:
a processor;
a flex sensor flexibly attached to a truss element of the roof truss;
a microcontroller coupled to the flex sensor to obtain a flex signal and produce flex data;
a memory in communication with the processor;
a wireless interface coupled to the microcontroller to transmit the flex data to the processor,
wherein the processor stores the flex data in the memory, compares the flex data with calibrated flex data to determine a beam deflection; and compares the beam deflection with a threshold value and, if the beam deflection is greater than the threshold value, generates an alert for an excessive snow load that may be displayed to a user via a graphical user interface (GUI).
